(19) United States
(12) Patent Application Publication
(10) Pub. No.: US 2018/0200549 A1
(43) Pub. Date: Jul. 19, 2018

(54) Aerosol Fire Extinguisher with Trigger Sprayer

(71) Applicants: Michael Fishman, Parkland, FL (US); Neal Markus, Hollywood, FL (US)

(72) Inventors: Michael Fishman, Parkland, FL (US); Neal Markus, Hollywood, FL (US)

(21) Appl. No.: 15/410,432

(22) Filed: Jan. 19, 2017

(51) Int. Cl. A62C 13/00; A62C 13/64

(52) U.S. Cl. CPC A62C 13/003; A62C 99/0036; A62C 13/64

(57) ABSTRACT

An Aerosol Fire Extinguisher with Trigger Sprayer that can be easily held in one hand that contains in one embodiment of the invention the fire extinguishing agent in a a bag under pressure in an aerosol can and can only be released by pulling the tab of the trigger assembly. In another embodiment of the invention the Aerosol Fire Extinguisher with Trigger Sprayer does not have a bag but utilizes traditional aerosol technology with unique gases. The trigger sprayer is open when the tab is pulled. The Aerosol Fire Extinguisher with trigger sprayer is cylindrical canister housing and a valve for directing the product flowing out of the can. Pulling the tab of the trigger assembly allows pivoting member of the trigger assembly to be able to press down on the stem of the mounting cup of the aerosol can which then allows the pressurized gas in the aerosol can to force the fire extinguishing liquid through the dip tube up through the direction hole into the direction chamber with pressure out the nozzle toward the fire. The user then sprays the fire with the extinguishing agent until the fire is out.

### CROSS-REFERENCE TO RELATED APPLICATIONS

U.S. Pat. No. 9,375,593 B2

### FEDERALLY SPONSORED RESEARCH

None

### SEQUENCE LISTING

None

### BACKGROUND

Traditional way of fighting fires is the use of a large Fire Extinguisher that can be bulky and has a complicated pull pin mechanism to dispense the fire extinguishing agent. This invention addresses a new way fighting fires using an aerosol can and trigger sprayer that is both easy to use and fast so the user would be able to pull the tab and spray a fire extinguishing agent onto the fire to put the fire out. Additionally this invention can easily be held in one hand ease of use. Because the fire extinguishing agent is under pressure in the aerosol it sprays onto the fire putting it out. In one embodiment of this invention the aerosol tire extinguisher liquid is a bag utilizing bag on valve aerosol technology.

### SUMMARY OF THE INVENTION

The invention is an aerosol fire extinguisher with a trigger sprayer. In a preferred embodiment of this invention bag on valve technology is used with the Fire Extinguishing Agent in a Bag and a trigger sprayer is utilized. When the Trigger is depressed the pressure of the propellant is exerted on the bag pushing the Fire Extinguishing Agent up the dip tube toward the Direction Chamber the Fire Extinguishing Agent then flows through the trigger sprayer to the nozzle where it will flow out toward the fire. The nozzle on the trigger sprayer can is configured to allow the fire extinguishing agent to flow out rapidly. There is a propellant inside the can with the Fire Extinguishing Agent. The Trigger sprayer of the aerosol fire extinguisher has a tab on top of it that can be easily be pulled off which allows the trigger to be depressed and ready to be used. When this tab is not pulled no liquid can come out of the aerosol fire extinguisher for easy storage. The Trigger can be depressed by an index finger to release the Fire Extinguishing Agent. The Trigger Sprayer has a nozzle wherein the Fire Extinguishing Agent can flow out. In another embodiment of the invention bag on valve technology is not employed but traditional aerosol technology is used. When the trigger sprayer is pressed the propellant in the can exerts pressure to force the extinguishing agent up the dip tube through the direction chamber then through the nozzle to extinguish the fire.

### OPERATION OF THE INVENTION

The operation of the Aerosol Fire Extinguisher with trigger sprayer is when it is needed for use the user simply pulls the tab of the fire extinguisher which is located on top and enables the trigger assembly to be pushed down on the mounting cup that has a stem sticking up that when depressed allows the propellant in the can to push the extinguishing liquid up through the stem through the trigger assemble to through the direction chamber through the direction hole toward the fire. In one embodiment of the invention there is a bag inside the can filled with the fire extinguishing mixture that is compressed from the propellant on the outside of the bag but inside the can. The Fires Extinguishing agent comes out with pressure and because the trigger assembly has a horizontal direction tube the user can easily identify the direction he/she is spraying toward.

### BRIEF DESCRIPTION OF THE DRAWINGS

FIG. 1 shows a perspective view of only the Can with the Mounting Cup and stem alone in a preferred embodiment of the invention.

FIG. 2 shows a perspective view of the Trigger Sprayer from the bottom of the Trigger in a preferred embodiment of the invention.

FIG. 3 Shows a perspective side view of the trigger sprayer with the tab intact,

FIG. 4 Shows a cross sectional view of the Trigger Sprayer with tab intact.

FIG. 5 shows front side view of the aerosol fire extinguisher with a trigger sprayer and tab intact in a preferred embodiment of the invention.

FIG. 6 shows a perspective view of the trigger sprayer looking from above.

FIG. 7 shows Perspective Cross Sectional view of the Aerosol Fire extinguisher with Mixture Agent with a Trigger Assembly and tab intact in a preferred embodiment of the invention utilizing bag on valve technology.

FIG. 8 shows a perspective view of the trigger sprayer on top of the can with bag on valve technology

### DETAILED DESCRIPTION

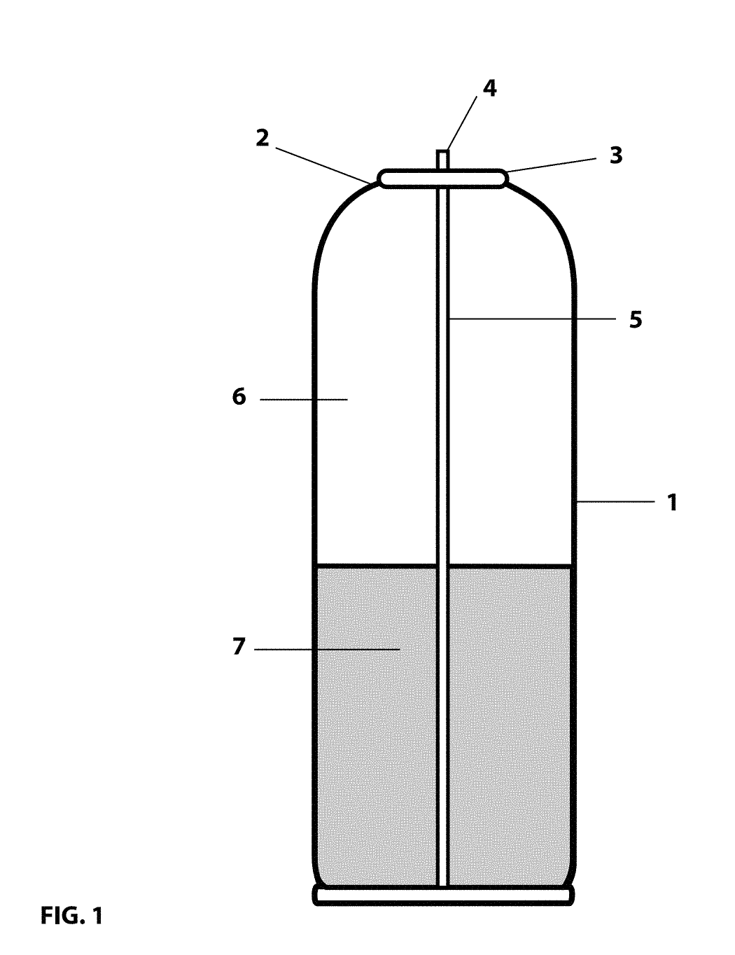

Referring now to FIG. 1, a preferred embodiment of the invention is a Can 1 that is strong enough to withhold aerosol can pressure. The Can 1 has a Can Hole 2 at the top of the can. A Mounting Cup 3 at the top of the can is configured to fit on top of Can 1 into the Can Hole 2. The Mounting Cup 3 has a Actuator Stem 4 which is attached to it and a Dip Tube 5 extends from the stem through the mounting cup into the Can 1. The Can 1 is filled partially with a Fire Extinguishing Agent 7 inside the can. The Can 1 is also filled partially with a Propellant 6. When the Actuator Stem 4 is depressed the Propellant 6 pushes the Fire Extinguishing Agent 7 up through the Dip Tube toward the Actuator Stem 4.

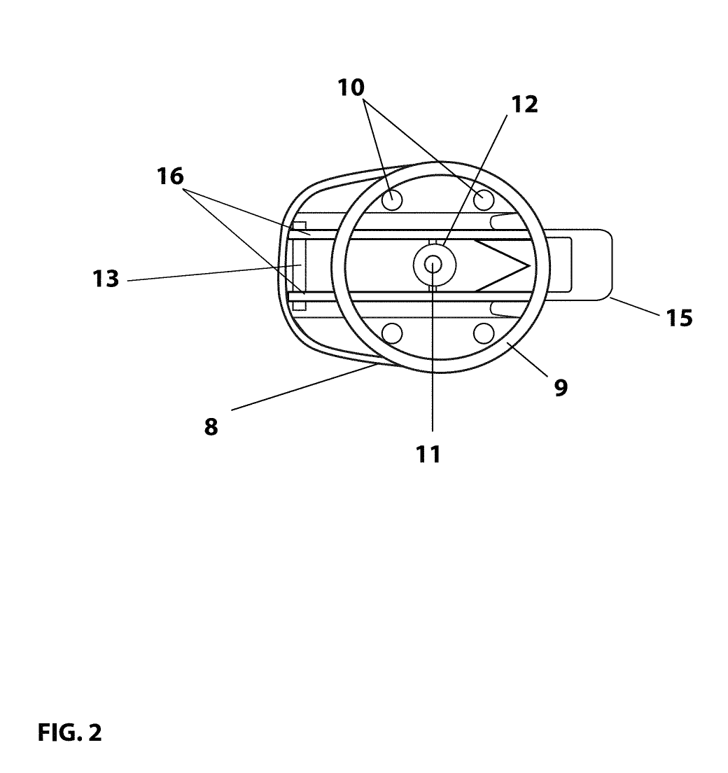

Referring now to FIG. 2 a preferred embodiment of the invention shows the bottom of a Trigger Spraying Unit 8 in a preferred embodiment of the invention. The Trigger Sprayer Unit fits onto the Mounting Cup 3 that is on the Can 1. The Trigger Sprayer unit 8 has a Rim 9 configured to snap onto the Mounting Cup 3. The Trigger Sprayer Unit also has one or more Fitting Units 10 that are configured to support and to grasp onto the Mounting Cup 3. The Trigger Sprayer Unit 8 has a Chamber Hole 11 which secures over the Actuator Stem 4. The Chamber Hole 11 leads into a Direction Chamber 12 and is attached to the back of the Trigger Sprayer Unit 8 by a Chamber Pivoting Member 13 that allows the Direction Chamber 11 to move up and down. The Direction Chamber 11 is configured to allow the Fire Extinguishing Agent 7 to flow upward and horizonytain the preferred embodiment of the invention. A Nozzle 14 is configured to allow the Fire Extinguishing Agent 8 to flow out and the user aims it toward the fire. A Trigger 15 is configured to be depressed by the index finger and attached to the Direction Chamber 12 in the preferred embodiment of the invention. The Trigger 15 can also be attached to the Nozzle 14 in other embodiments of the invention. The Trigger 15 is also configured to have the a part if it attach to the back of the Trigger Sprayer Unit. A Trigger Pivoting Member 16 allows the trigger to move up an down and work contingently with the Direction Chamber 12.

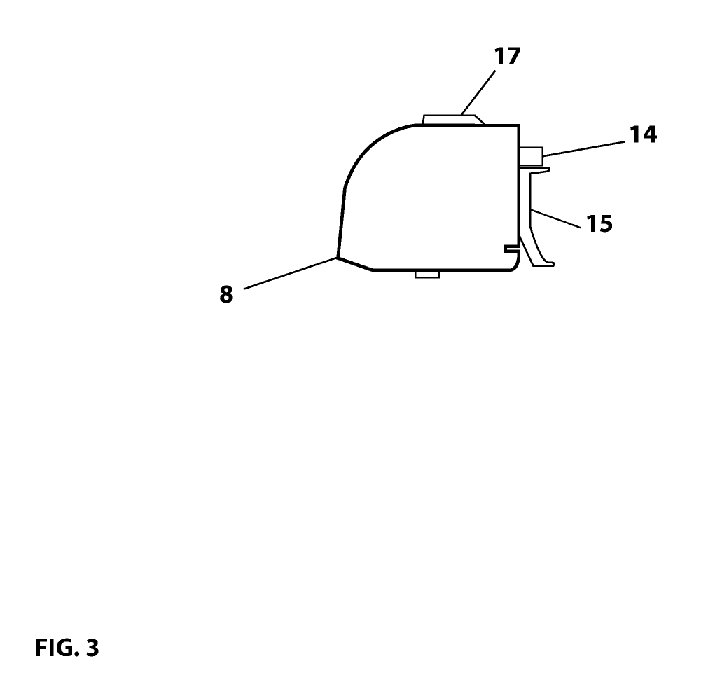

Referring now to FIG. 3 a preferred embodiment of the invention shows a perspective side view of the Trigger Sprayer Unit 8. A Tab 17 is fitted on top of the trigger which is attached to the Nozzle 14 and the Trigger 15. in a preferred embodiment of the invention the Tab 17 must be removed for the Nozzle 14 and Trigger 15 to move. It is the movement of the Nozzle 14 and the Trigger 15 contingent with the Direction Chamber 12 on to the Actuator Stem 4 that causes the Fire Extinguishing Agent 7 to be forced up through the Dip Tube 5 into the Direction Chamber 12 from the release of pressure.

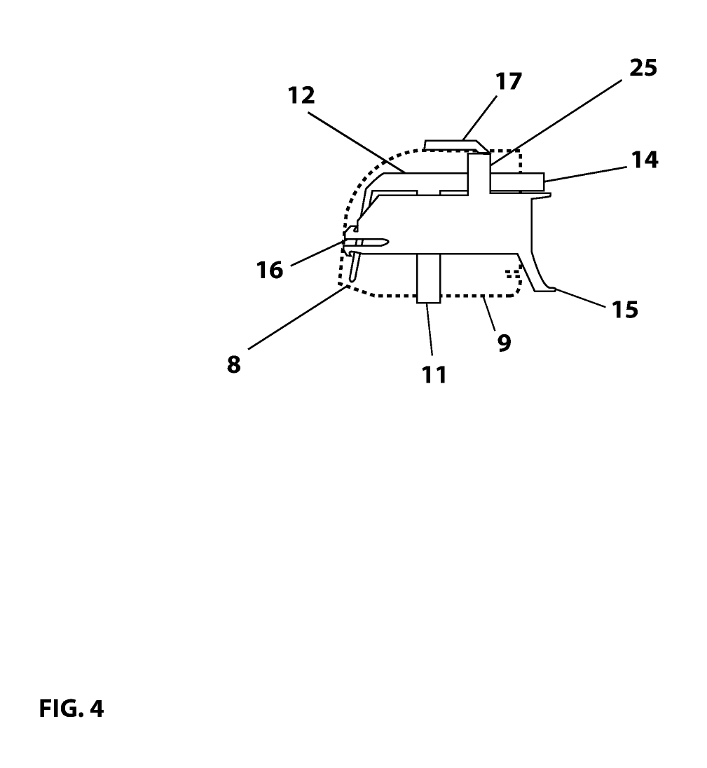

Referring now to FIG. 4 a cross sectional view of the Trigger Sprayer,

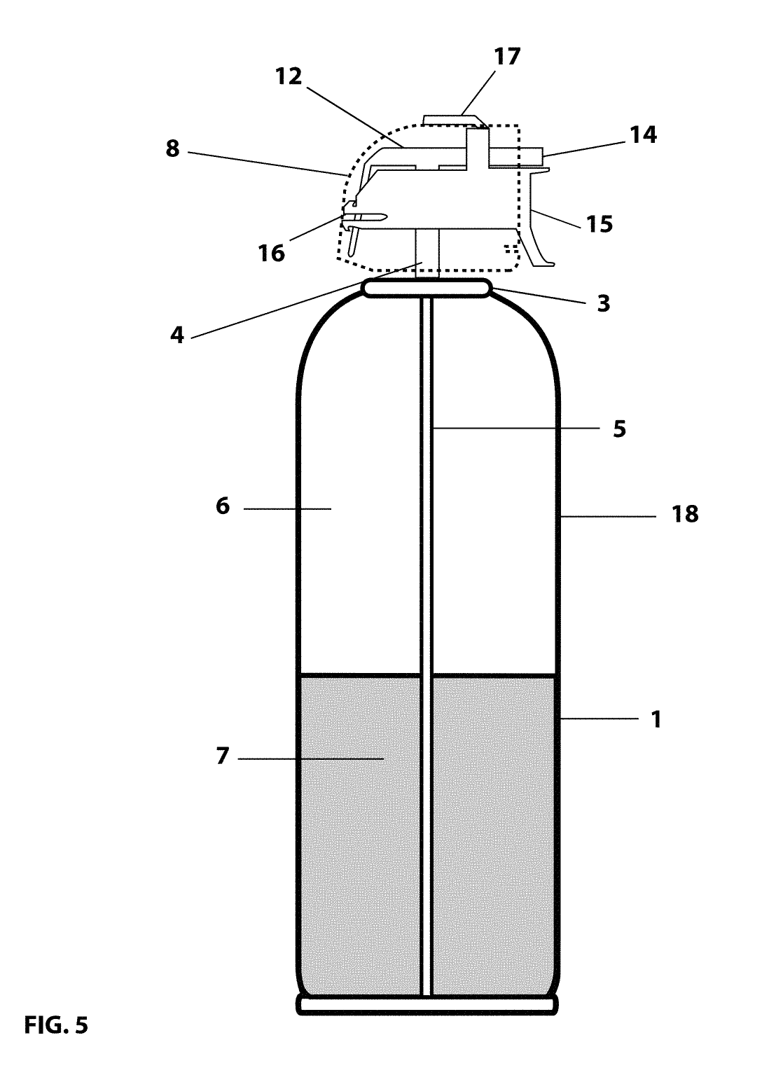

Referring now to FIG. 5 which shows a perspective side view of the aerosol fire extinguisher unit. A aerosol fire extinguisher whole unit 18 is shown.

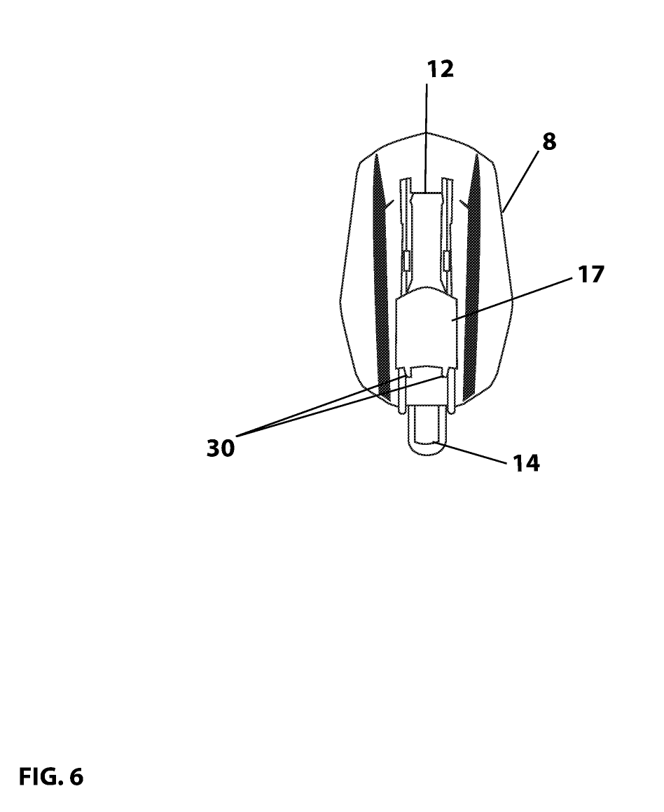

Referring now to FIG. 6 shows a view of the trigger sprayer looking from above. The Tab 17 is shown as it sits on top of the Trigger Sprayer Unit 8. In this perspective view the tab has breakaway Hinges 30 that allows the Tab 17 to be pulled off. When the Tab 17 is pulled off. When the Tab 17 is pulled off the Nozzle 14 and Direction Chamber 12 are free to pivot and move up and down on the trigger 15 is pressed.

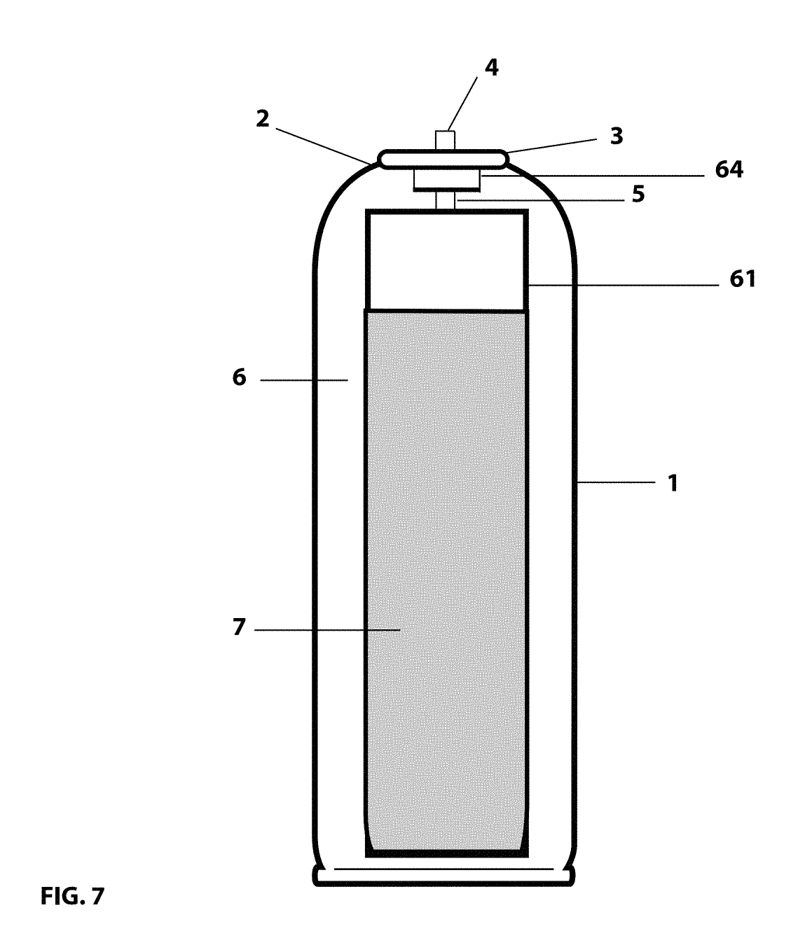

Referring now to FIG. 7 which shows a perspective side view of Fire Extinguishing Agent with Trigger Sprayer. In this perspective view the Can 1 is shown filled with the Fire Extinguisher Mixture Agent. The Can 1 is filled with the Propellant 6 composed of nitrogen, air or mixture thereof and the Dip Tube 5 goes to the Bag 61 of the fire Extinguisher Mixture Agent. The Dip Tube 5 then connects to the Valve Operative 64 which is configured to go through the Mounting Cup 3. A Mounting Cup 3 holds the pressure inside the Can 1. The Propellant 6 can also be The Propellant 6 can also be composed of 1,1,1,2-Tetrafluoroethane, Difluoroethane, Petroleum Hydrocarbon, CO2, HFC1234ze.

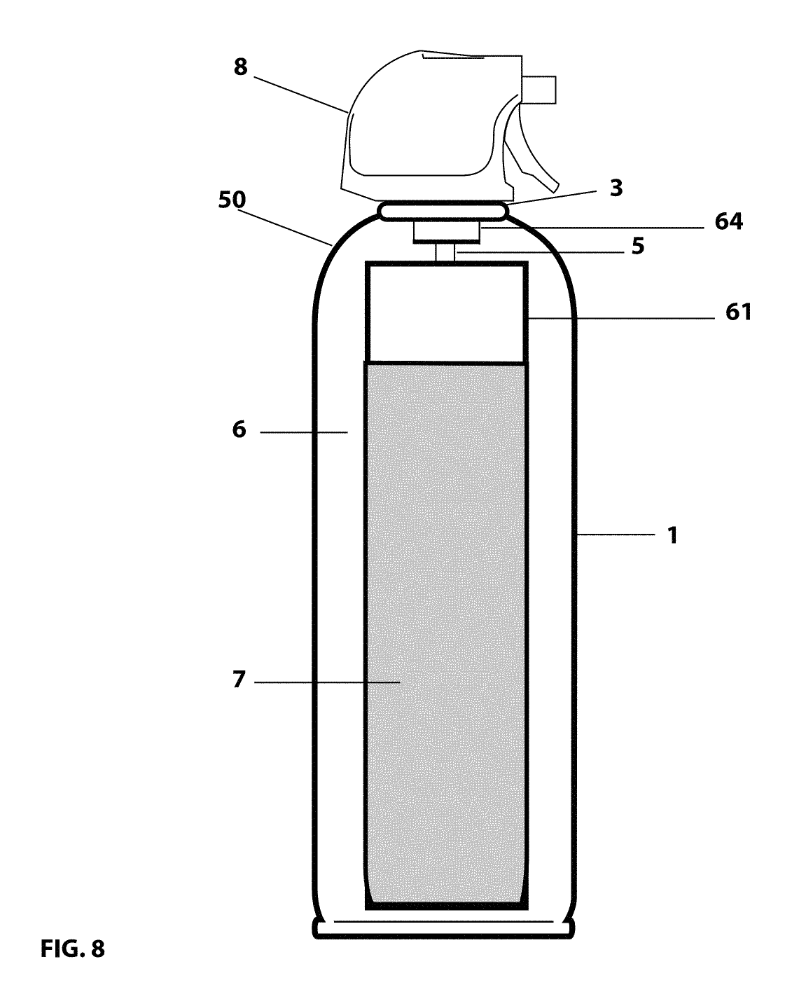

Referring now to FIG. 8 shows the perspective side view of the Fire Extinguishing Agent with Trigger Sprayer is the preferred embodiment in the invention. The Whole Unit 50 is shown as whole invention. In this perspective view the Can 1 is shown filled with the Fire Extinguisher Mixture Agent. The Can 1 is filled with the Propellant 6 composed of nitrogen, air or mixture thereof and the Dip Tube 5 goes to the Bag 61 of the fire Extinguisher Mixture Agent. The Dip Tube 5 then connects to the Valve Operative 64 which is configured to go through the Mounting Cup 3. A Mounting Cup 3 holds the pressure inside the Can 1. The Trigger Assembly 8 fits onto the Mounting Cup 3. The Propellant 6 can also be The Propellant 6 can also be composed of 1,1,1,2-Tetrafluoroethane, Difluoroethane, Petroleum Hydrocarbon, CO2, HFC1234ze.

1. The invention is:
A. Aerosol fire Suppressant Mixture Agent with Trigger Sprayer comprising:
1. (a) A Can storing a percentage of AFFF Mixture Agent in a bag under pressure from a propellant having an opening for discharge for AFFF there through;
(b). A Valve Operative for receiving the AFFF Mixture Agent from the opening;
(c) a Trigger Assembly having a nozzle operative for discharging the AFFF Mixture Agent from the container through the Valve Operative, the Trigger Assembly having a Trigger for opening and closing the Valve Operative to selectively discharge the AFFF Mixture Agent from the Opening of the Nozzle
(d) the Trigger is operable by pulling the trigger towards the can using one's index finger for opening the Valve Operative and for closing the Valve Operative by releasing the trigger.
(e) a propellant on outside of the bag inside the can putting pressure on the bag that pushers the AFFF Mixture Agent out of the Opening of the Nozzle when the Valve Operative is opened.

2. The invention is:
A. Aerosol Fire Suppressant mixture agent with Trigger Sprayer comprising:
1. (a) A Can with AFFF Mixture Agent under pressure from a propellant having an opening for discharge for AFFF Mixture Agent there through;
(b). A Valve Operative for receiving the AFFF Mixture Agent from the opening;
(c) Trigger Assembly having a nozzle operative for discharging AFFF Mixture Agent from the container through the Valve Operative, the Trigger Assembly having a Trigger for opening and closing the Valve Operative to selectively discharge the Aerosol AFFF Agent from the Opening of the Nozzle
(d) the Trigger is operable by pulling the trigger towards the container using one's index finger for opening the Valve Operative and for closing the Valve Operative by releasing the trigger.
(e) the propellant being 1,1,1,2-Tetrafluoroethane, Difluoroethane, Petroleum Hydrocarbon, CO2, HFC1234ze.

3. The invention is:
A. Aerosol Fire Suppressant mixture agent with Trigger Sprayer with comprising:
1. (a) A Container storing AFFF Mixture Agent in a bag filled under pressure from a propellant made of oxygen or nitrogen having an opening for discharge for AFFF Mixture Agent there through;
(b). A Valve Operative for receiving the AFFF Mixture Agent from the opening;
(c) trigger sprayer unit having a nozzle operative for discharging the Aerosol Fire Suppressant Mixture Agent from the container through the Valve Operative, the Trigger Assembly having a Trigger for opening and closing the Valve Operative to selectively discharge the AFFF Mixture Agent from the Opening of the Nozzle.
(d) the Trigger is operable by pulling the trigger towards the container using one's index finger for opening the Valve Operative and for closing the Valve Operative by releasing the trigger.

4. The invention as recited in claim 1 wherein the propellant comprises 1,1,1,2-Tetrafluoroethane, Difluoroethane, Petroleum Hydrocarbon, CO2, HFC1234ze or any percentages thereof.

5. The invention as recited in claim 1 wherein the propellant comprises percentages of oxygen or nitrogen

6. The invention as recited in claim 1 wherein the propellant comprises a mixture of Oxygen and Nitrogen.

7. The invention as recited in claim 1 where in the can holds 1 to 24 fl oz.

8. The invention recited in claim 1 wherein the Trigger moves up and down and moves the Nozzle which then Pivots causing the Actuator Stem to release pressure causing the AFFF Agent to Flow up into the Direction Chamber and out the Nozzle.

9. The invention recited in claim 1 wherein the AFFF Mixture Agent comprises a percentage of water and AFFF.

10. The invention recited in claim 1 wherein the AFFF Mixture Agent comprises a percentage of AFFF and water wherein the water added is distilled, artesian, mineral, public water source; purified; sparkling or spring.

11. The invention recited in claim 1 wherein the AFFF Mixture Agent comprises 100 percent AFFF

12. The invention as recited in claim 2 wherein there is a tab on the trigger sprayer and the Tab when not removed locks the AFFF Mixture Agent and prevents it from easily being dispensed for storage and non-tampering.

13. The invention as recited in claim 3 wherein the can has a longitudinal axis and the trigger is movable in a direction perpendicular to the longitudinal axis.

14. The invention as recited in claim 1 wherein the can is made of metal such as aluminum or steel or plastic or combination thereof.

15. The invention as recited in claim 1 wherein the Trigger assembly is made of metal such as aluminum or steel or plastic or a combination of thereof.

16. The Invention as recited in claim 1 wherein a Aerosol Fire Suppressant with Trigger Sprayer is a System for putting out fires.

17. The invention in claim 1 wherein the spray cone has a diameter of 2 inches at 5 inches from the opening of the nozzle of the trigger assembly.

18. The Invention as recited in claim 1 wherein the Propellant is composed of nitrogen, oxygen, air 1,1,1,2-Tetrafluoroethane, Difluoroethane, Petroleum Hydrocarbon, CO2, HFC1234ze, individually or mixture thereof.
